(19) United States
(12) Patent Application Publication
(10) Pub. No.: US 2001/0038477 A1
(43) Pub. Date: Nov. 8, 2001

(54) High-isolation wavelength managing module for bi-directional wavelength division multiplexing optical communication system

(75) Inventor: Yu-Wen Hwang, Hsinchu (TW)

Correspondence Address: Daniel R. McClure, THOMAS, KAYDEN, HORSTEMEYER & RISLEY, L.L.P., Suite 1750, 100 Galleria Parkway N.W., Atlanta, GA, 30339, US

(73) Assignee: Browave Corporation, Hsinchu (TW)

(21) Appl. No.: 09/767,437

(22) Filed: Jan. 23, 2001

(30) Foreign Application Priority Data
May 6, 2000 (TW) 89108699

(51) Int. Cl. H04J 14/02

(52) U.S. Cl. 359/124; 359/127

(57) ABSTRACT

A high-isolated wavelength managing module, having four ports, has at least a first, a second and a third wavelength managing modules, and the optical circulators comprise a first and a second optical circulators. The first wavelength managing module receives and carries first optical signals with different wavelengths, and the third wavelength managing module receives and carries second optical signals with different wavelengths, the first and the second optical signals are transmitted in opposite direction and with different wavelengths. The first optical circulator is connected between the first and the third wavelength managing module and the second optical circulator is connected between the second and the third wavelength managing module. Further, the third wavelength managing module can be omitted and the first and the second optical circulator are directly connected. In addition, the high-isolated wavelength managing module can also comprise a number of wavelength managing modules with self-loops and a wavelength managing module without self-loops.

### CROSS-REFERENCE TO RELATED APPLICATION

This application claims the priority benefit of Taiwan application Ser. No. 89108699, filed May 6, 2000.

### BACKGROUND OF THE INVENTION

1. Field of Invention

The present invention relates to a wavelength managing module. More particularly, the present invention relates to a high-isolation wavelength managing module.

2. Description of Related Art

In accordance with high development in the information technology field, and in order to satisfy general communication needs, wavelength division multiplexing technology is used on optical transmission paths in addition to the building of new optical fibers. Wavelength division multiplexing technology is capable of transmitting optical signals, having different wavelengths, on an optical fiber simultaneously in order to increase transmission ability.

Historically, the transmission rate for optical fiber has increased quadruply every five years. Currently, the transmission rate of commercial SDH (synchronous digital hierarchy) is up to 10 GBPS (gigabyte per second) due to the use of high-speed TDM circuit technology. However, use of TDM circuit technology for increasing the transmission rate for optical fiber has reached a bottleneck. In addition, a wavelength division multiplexer (WDM) having an erbium doped fiber amplifier (EDFA) benefits from optical fibers that use high bandwidth, and therefore, hundreds of optical signals having different wavelengths can be simultaneously transmitted on the same optical fiber within a wavelength range of 1.5 mm. Accordingly, the ability for transmitting optical signals increases.

WDM technology is currently popular and well developed. However, most of the optical signals transmitted in the same optical fiber propagate in the same direction. Even if few existing systems can perform bi-directional transmissions, the optical isolation degree (only about 30 dB) for those systems according to the current method does not satisfy requirements for high-quality communication.

### SUMMARY OF THE INVENTION

The present invention provides a structure of a high-isolated wavelength managing module. The structure can be applied to a bidirectional wavelength multiplexing communication system for performing optical function operations, such as amplifying optical signals for different wavelengths, optical add and drop multiplexing at an node, and wavelength crossconnect for different wavelengths on different optical transmission lines.

The high-isolated wavelength managing module comprises a plurality of wavelength managing modules, such as, for example, two or three wavelength managing modules. In regard to three wavelength managing modules, each module has four ports. The first port of the first wavelength managing module is connected to the first port of the high-isolated wavelength managing module for receiving and carrying first optical signals with different wavelengths. The fourth port of the second wavelength managing module is connected to the fourth port of the high-isolated wavelength managing module for receiving and carrying second optical signals with different wavelengths. The second port of the third wavelength managing module is connected to the second port of the high-isolated wavelength managing module. The first and the second optical signals are transmitted in opposite directions and with different wavelengths. In addition, the high-isolated wavelength managing module further comprises at least two optical circulators. For the first optical circulator, its first port is connected to the second port of the first wavelength managing module, the second port is connected to the first port of the third wavelength managing module, and the third port is connected to the third port of the first wavelength managing module. For the second optical circulator, its first port is connected the second port of the second wavelength managing module, the second port is connected to the fourth port of the third wavelength managing module, and the third port is connected to the third port of the second wavelength managing module.

With regard to two wavelength managing modules, the first wavelength managing module is connected to the first port of the high-isolated wavelength managing module, and the second wavelength managing module is connected to the fourth port of the high-isolated wavelength managing module. The first and second optical circulators are respectively connected to the first and the second wavelength managing modules. Further, the first and the second optical circulators are connected together, such that the first wavelength managing module, the first optical circulator, the second optical circulator, and the second wavelength managing module form an optical transmission channel.

The present invention further provides a high-isolated wavelength managing module using 2×2 components as the wavelength managing module. Optical fiber loops of the 2×2 wavelength managing module form a so-called self-loop for increasing isolation of the wavelength managing module. The high-isolated wavelength managing module comprises a number of wavelength managing modules with self-loops and a wavelength managing modules without self-loops. The high-isolated wavelength managing module also comprises a number of 2×2 wavelength managing modules having similar optical properties, which cost can be reduced and device specification can be consistent. The high-isolated wavelength managing module has first, second, third and fourth ports, which each comprise a plurality of wavelength managing modules having self-loops and a wavelength managing module without self-loops. One port of one of the wavelength managing modules with self-loops is connected to the first port of the high-isolated wavelength managing module for receiving and carrying first optical signals with different wavelengths, and one port of another wavelength managing module with self-loops is connected to the fourth port of the high-isolated wavelength managing module for receiving and carrying second optical signals with different wavelengths. The first and the second optical signals are transmitted in opposite directions and with different wavelengths. The wavelength managing module without self-loops, is coupled between the wavelength managing modules with self-loops.

In general, when the wavelength managing module performs wavelength add and drop multiplexing process, a channel spacing (CS) is defined as the difference of neighboring wavelengths between up-transmitting and down-transmitting optical signals. As the channel (wavelength) number increases, a small CS is required, causing difficulty in making an optical add and drop multiplexer. In the present invention, the structure of the high-isolated wavelength managing module is modified such that the add and drop multiplexing process on the up-transmitting and down-transmitting optical signals, are separately carried out. Accordingly, the requirement of the CS of the add and drop multiplexer can be less critical. In other word, the high-isolated wavelength managing module of the present invention can separately carry out the add and drop multiplexing process for the up-transmitting and down-transmitting optical signals, thereby increasing flexibility of design and signal process of the bi-directional wavelength multiplexing communication system.

### BRIEF DESCRIPTION OF THE DRAWINGS

While the specification concludes with claims particularly pointing out and distinctly claiming the subject matter which is regarded as the invention, the objects and features of the invention and further objects, features and advantages thereof will be better understood from the following description taken in connection with the accompanying drawings in which:

FIG. 1 is a bi-directional wavelength multiplexing optical communication system of the present invention.

FIG. 2 shows a high-isolated bi-directional optical function module of the present invention.

FIG. 3 is a schematic diagram showing the high-isolated wavelength managing module.

FIG. 4 is an experimental result deduced from a theoretical analysis for a MWDM made by UMZI technology, in which an optical loss due to manufacturing process is omitted.

FIG. 5 shows an architecture with optical adding and dropping multiplexing capability using the high-isolated wavelength managing module of FIG. 1.

FIG. 6 shows an architecture having a dispersion compensator which uses the high-isolated wavelength managing module.

FIG. 7 schematically shows a system block diagram wherein optical signals (information) are exchanged between k bi-directional wavelength multiplexing communication systems.

FIG. 8 schematically shows a block diagram of the bi-directional wavelength interconnect 730.

FIG. 9 shows a block diagram of a high-isolated bi-directional optical function module which modifies the high-isolated wavelength managing module to enable the capability of performing the add-drop process and then amplifying “west-to-east” and “east-to-west” wavelength multiplexing optical signals.

FIG. 10 shows a block diagram of a high-isolated bi-directional optical function module which modifies the high-isolated wavelength managing module to enable the capability of performing a wavelength crossconnect process and then amplifying the “west-to-east” and “east-to-west” wavelength multiplexing optical signals.

FIGS. 11 and 12 show two variations of the high-isolated wavelength managing modules of the present invention.

FIG. 13A shows a wavelength managing module 321, which is a 2×2 MWDM device having self-loops.

FIG. 13B shows a wavelength managing module 322, which is a 2×2 MWDM device having self-loops.

FIG. 14 shows a schematic diagram of a high-isolated wavelength managing module.

FIG. 15 shows a structure how to use the high-isolated wavelength managing module shown in FIG. 14 such that the “west-to-east” and “east-to-west” optical signals of the high-isolated bi-directional optical function module can be amplified or added and dropped.

FIG. 16 shows an alternate embodiment of the high-isolated wavelength managing module according to the present invention.

FIG. 17 shows a structure that the high-isolated wavelength managing module in FIG. 16 is applied to the high-isolated bi-directional optical function module, such that the “west-to-east” and “east-to-west” optical signals of the high-isolated bi-directional optical function module can be amplified or added and dropped.

### DETAILED DESCRIPTION OF PREFERRED EMBODIMENTS

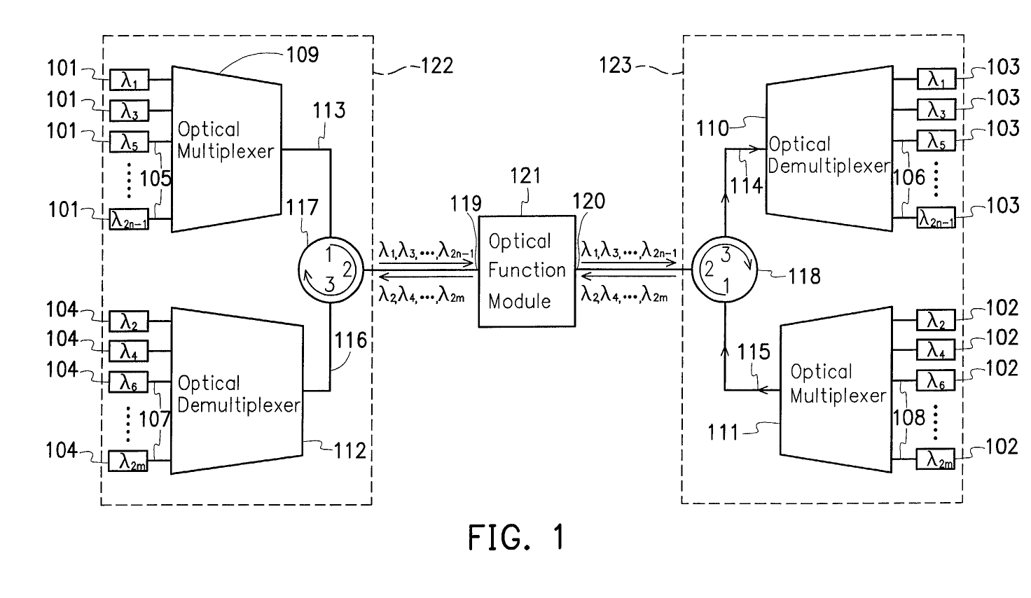

FIG. 1 illustrates a bi-directional wavelength multiplexing optical communication system of the present invention. The system comprises a set of optical transceivers 101 from a “west” node to an “east” node, and a set of optical transceivers 102 from the “east” node to the “west” node. The phrases “from a west node to an east node” and “from the west node to the east node” represent transmission directions of optical signals transmitting within the optical communication system. The optical transmitters carrying optical signals from west to east and the optical transmitters carrying optical signals from east to west are disposed on the opposite ends of the transmission lines of the optical communication system. For convenience, the “west” represents the left of the drawings and the “east” represents the right of the drawings, but this is not intended to restrict the scope of the present invention, but instead, is merely offered as an example.

Each of the optical transceivers 101 and 102 transmit or receive an optical signal with a specific wavelength, carrying encoded optical signals comprising audio signals, video signals and/or computer information. As shown in FIG. 1, the optical transceivers 101 transmit optical signals with wavelengths λ1, λ3, λ5 and λ2n−1, respectively while the optical transceivers 102 transmit optical signals with wavelengths λ2, λ4, λ6 and λ2m−1, respectively, in which m and n are integrals and represent a maximum number for each transmission direction.

The optical signals having wavelengths λ1, λ3, λ5 and λ2n−1 out of the optical transceivers 101 are transmitted through optical transmission lines 105, to an optical multiplexer 109, and then are combined on an optical transmission line 113. Similarly, the optical signals with wavelengths λ2, λ4, λ6 and λ2m−1 out of the optical transceivers 102 are transmitted through optical transmission lines 108 to an optical multiplexer 111, and then are combined on an optical transmission line 115. The optical multiplexers 109, 111 can be made by any optical fiber passive device, capable of converging optical signals with different wavelengths into a signal common output port.

The optical signals from the optical transceivers 101 are converged into a set of “west-to-east” wavelength multiplexing optical signals, which are input to port 1 of an optical circulator 117 and then outputted from port 2 of the optical circulator 117 onto an optical transmission line 119. Similarly, the optical signals from the optical transceivers 102 are converged into a set of “east-to-west” wavelength multiplexing optical signals, which are input to port 1 of an optical circulator 118 and then outputted from port 2 of the optical circulator 118 onto an optical transmission line 120.

The “west-to-east” wavelength multiplexing optical signals are passed through one or more optical function modules 121, transmitted to port 2 of the optical circulator 118, and then redirected to port 3 of the optical circulator 118. The “west-to-east” wavelength multiplexing optical signals are finally transmitted to an optical demultiplexer 110 through an optical transmission line 114. The combined optical signal is demultiplexed into optical signals, which are respectively transmitted to corresponding optical transceivers 103 through optical transmission lines 106. Similarly, the “east-to-west” wavelength multiplexing optical signals are passed through one or more optical function modules 121, transmitted to port 2 of the optical circulator 117, and then redirected to port 3 of the optical circulator 117. The “east-to-west” wavelength multiplexing optical signals are finally transmitted to an optical demultiplexer 112 through an optical transmission line 116. The combined optical signal is demultiplexed into optical signals, which are respectively transmitted to corresponding optical transceivers 104 through optical transmission lines 107.

A high-isolated bi-directional optical function module 121 is capable of providing a variety of optical functions for different optical wavelengths, such as amplifying optical signals, add and drop multiplexing for optical wavelengths on an optical node, compensating dispersion for different wavelengths and wavelength crossconnecting on different transmission lines for different wavelengths.

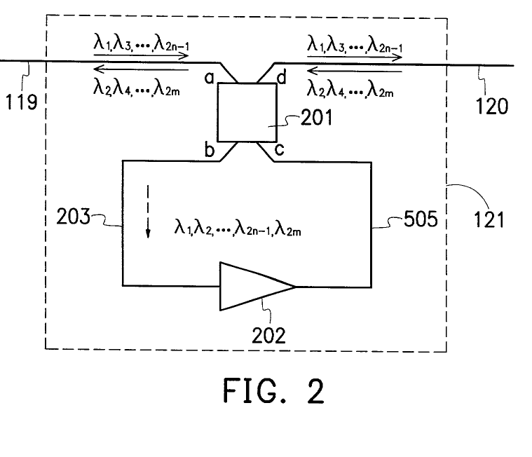

FIG. 2 shows a high-isolated bi-directional optical function module in accordance with of the present invention. As shown, the high-isolated bi-directional optical function module 121 can, for example, be used for amplifying optical signals with different wavelengths such that the optical signals can propagate for a longer distance. After the “west-to-east” wavelength multiplexing optical signals enter port a of the high-isolated wavelength managing module 201 and are redirected to port b of the high-isolated wavelength managing module 201, the optical signals are transmitted to an optical transmission line 203. Meanwhile, after the “east-to-west” wavelength multiplexing optical signals enter port d of the high-isolated wavelength managing module 201 and are redirected to port b of the high-isolated wavelength managing module 201, the optical signals are transmitted to the optical transmission line 203. Therefore, the “west-to-east” and “east-to-west” wavelength multiplexing optical signals are merged on the optical transmission line 203 and propagate uni-directionally along the optical transmission line 203. Amplified by an optical amplifier module 202, the amplified optical signals are transmitted to port c of the high-isolated wavelength managing module 201. The “west-to-east” wavelength multiplexing optical signals are outputted from port d of the high-isolated wavelength managing module 201 and transmitted along the optical transmission line 120 from west to east. Meanwhile, the “west-to-east” wavelength multiplexing optical signals are outputted from port a of the high-isolated wavelength managing module 201 and then transmitted along the optical transmission line 119 from east to west.

Generally, the optical amplifier module 202 may comprise, for example, an erbium doped fiber amplifier (EDFA), and comprises an optical fiber isolator, a wavelength multiplexer (for 980/1550 nm or 1480/1550 nm), an erbium doped fiber and a light source (such as a laser diode of wavelength 980 nm or 1480 nm).

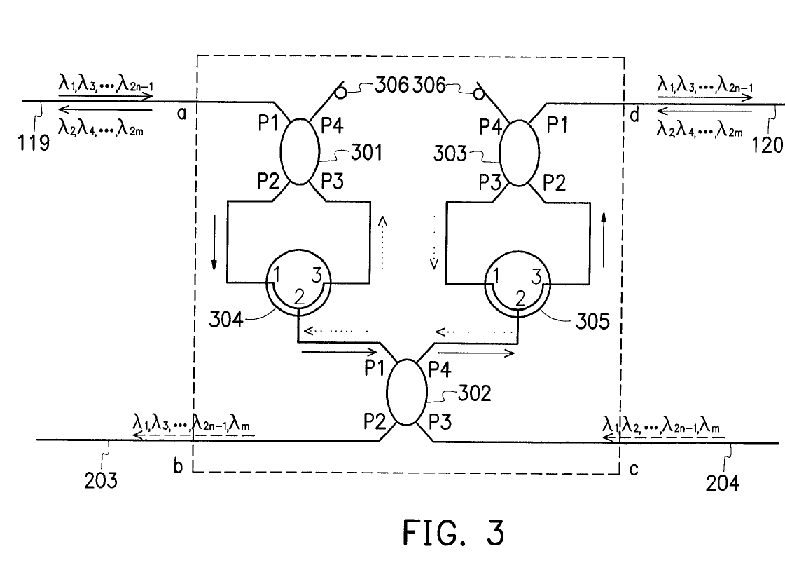

FIG. 3 is a schematic diagram showing the high-isolated wavelength managing module. As shown, it comprises at least three wavelength managing modules 301, 302 and 303, each consisting of four ports p1˜p4. The first port p1 (the first port a of the high-isolated wavelength managing module 201) of the first wavelength managing module 301 is connected to a first set of signals carrying wavelength multiplexing optical signals with different wavelengths, and the fourth port p4 (the fourth port d of the high-isolated wavelength managing module 201) of the second wavelength managing module 303 is connected to a second set of signals carrying wavelength multiplexing optical signals with different wavelengths. The second port p2 of the third wavelength managing module 302 serves as the second port b of the high-isolated wavelength managing module 201, while the third port p3 of the third wavelength managing module 302 serves as the third port c of the high-isolated wavelength managing module 201. The first and second sets of signals propagate in opposite direction and carry different wavelengths. The high-isolated wavelength managing module further comprises at least two optical circulators 304, 305, in which the first port 1 of the first optical circulator 304 is connected to the second port p2 of the first wavelength managing module 301, the second port 2 of the first optical circulator 304 is connected to the first port p1 of the third wavelength managing module 302, and the third port 3 of the first optical circulator 304 is connected to the third port p3 of the first wavelength managing module 301. Meanwhile, the first port 1 of the second optical circulator 305 is connected to the second port p2 of the second wavelength managing module 303, the second port 2 of the second optical circulator 305 is connected to the fourth port p4 of the third wavelength managing module 302, and the third port 3 of the second optical circulator 305 is connected to the third port p3 of the second wavelength managing module 303.

As shown, the “west-to-east” wavelength multiplexing optical signals reach port p1 of the first wavelength managing module 301 as soon as they enter the high-isolated wavelength managing module 201 from port a, and are then transmitted from port p2 of the first wavelength managing module 301 to port 1 of the first optical circulator 304. Passing through the first optical circulator 304, the “west-to-east” wavelength multiplexing optical signals are outputted from port 2 of the first optical circulator 304 and transmitted to the first port p1 of the third wavelength managing module 302, and then outputted from port 2 of the third wavelength managing module 302 to the optical transmission line 203. Meanwhile, the “east-to-west” wavelength multiplexing optical signals reach the port p4 of the second wavelength managing module 303 as soon as they enter the high-isolated wavelength managing module 201 from port d, and then are transmitted from port p2 of the second wavelength managing module 303 to port 1 of the second optical circulator 305. Passing through the second optical circulator 305, the “west-to-east” wavelength multiplexing optical signals are outputted from port 2 of the second optical circulator 305 and transmitted to the fourth port p4 of the third wavelength managing module 302, and then outputted from port 2 of the third wavelength managing module 302 to the optical transmission line 203. Therefore, the “west-to-east” and “east-to-west” wavelength multiplexing optical signals merge on the optical transmission line 203 and are transmitted along the same direction.

After being amplified by the optical function module (such as the optical amplifier module), the merged or combined wavelength multiplexing optical signals are transmitted to port c of the high-isolated wavelength managing module 201 through the optical transmission line 204, and then to the third port p3 of the third wavelength managing module 302. The “west-to-east” wavelength multiplexing optical signals are outputted from the fourth port p4 of the third wavelength managing module 302 and then transmitted to the second port p2 of the second optical circulator 305. Passing through the second optical circulator 305, the “west-to-east” wavelength multiplexing optical signals are outputted from the third port p3 of the second optical circulator 305 and then transmitted to the third port p3 of the second wavelength managing module 303, and finally outputted from the fourth port p4 of the second wavelength managing module 303 to the optical transmission line 120. Similarly, The “east-to-west” wavelength multiplexing optical signals are outputted from the first port p1 of the third wavelength managing module 302 and then transmitted to the second port p2 of the first optical circulator 304. Passing through the first optical circulator 304, the “east-to-west” wavelength multiplexing optical signals are outputted from the third port p3 of the first optical circulator 304 and transmitted to the third port p3 of the first wavelength managing module 301, and finally outputted from the first port p1 of the first wavelength managing module 301, to the optical transmission line 119.

In general, the wavelength managing modules 301, 302 and 303 can be, for example, multi-window wavelength division multiplexers (MWDM), fabricated by fused-biconical taper method (FBT) or unbalanced Mach-Zehnder interferometer (UMZI) technology. The wavelength managing module is also named as an optical wavelength interleaver because wavelengths are interleavely appeared and distributed on their two output ports when a number of wavelengths with constant frequency spacings are inputted to such module.

The wavelength multiplexing optical signals pass the general wavelength managing module four times (once for the first wavelength managing module 301, twice for the second wavelength managing module 302 and once for the third wavelength managing module 303) and the optical circulators twice (once for the first and second optical circulators 304, 305 respectively) when they enter the high-isolated wavelength managing module 201.

According to the commercial MWDM and optical circulator, the insertion loss for the high-isolated wavelength managing module is larger than that for the general wavelength managing module loss by about 2.2˜2.6 dB. However, the isolation property of the high-isolated wavelength managing module is better than the general wavelength managing module.

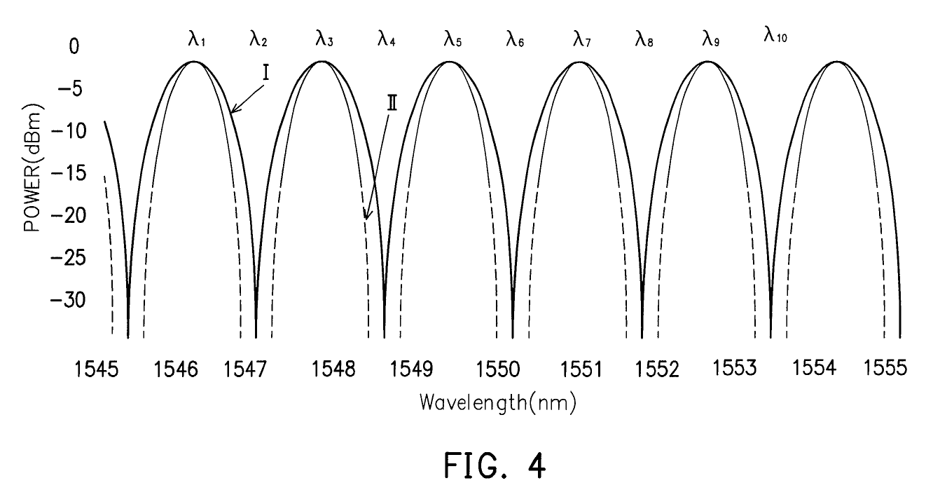

In addition, optical terminators 306 should be installed on the fourth port p4 of the first wavelength managing module 301 and on the first port p1 of the second wavelength managing module 301 for avoiding unnecessary noise resulting in signal reflection by feedback device at the terminals. In general, a micro-bending method or cutting the end of the optical fiber by 8 degrees is used to form the optical terminator 306 for reducing noise. FIG. 4 is an experimental result deduced from a theoretical analysis for a MWDM made by unbalanced Mach-Zehnder interferometer (UMZI) technology, in which an optical loss due to manufacturing process is omitted. In FIG. 4, a solid line I shows a spectrum that the optical signals pass the wavelength managing module twice, while a dash line II shows a spectrum that the optical signals pass the wavelength managing module four times. As shown, within the same bandwidth, the channel isolation for passing the wavelength managing module four times is double of the channel isolation for passing the wavelength managing module twice, but the insertion loss is also double.

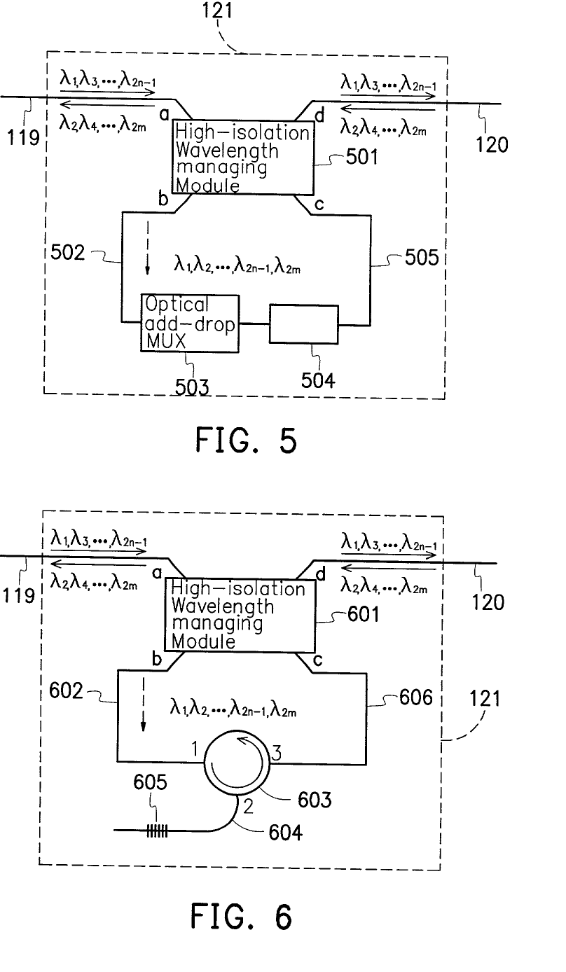

FIG. 5 shows an architecture with optical adding and dropping multiplexing capability which uses the high-isolated wavelength managing module. The “west-to-east” wavelength multiplexing optical signals are inputted to port a of a high-isolated wavelength managing module 501, outputted from port b of the high-isolated wavelength managing module 501, and then propagate on an optical transmission line 502. Meanwhile, the “east-to-west” wavelength multiplexing optical signals are inputted to port d of the high-isolated wavelength managing module 501, outputted from port b of the high-isolated wavelength managing module 501, and then propagate on an optical transmission line 502. Therefore, the “west-to-east” and “east-to-west” wavelength multiplexing optical signals are merged or combined on the optical transmission line 502 and then transmitted along the same direction. After optical signals with one or more wavelengths are added or dropped by an optical adding and dropping multiplexer 503, the merged or combined optical signals are passed through an optical isolator 504, and then transmitted to port c of the high-isolated wavelength managing module 501 through an optical transmission line 505. The “west-to-east” wavelength multiplexing optical signals are then outputted from port d of the high-isolated wavelength managing module 501, and continuously transmitted from west to east along the optical transmission line 120. At this time, the “east-to-west” wavelength multiplexing optical signals are outputted from port a of the high-isolated wavelength managing module 501, and continuously transmitted from east to west along the optical transmission line 119 (connected to the first port of the high-isolated wavelength managing module).

The optical fiber isolator 504 is used to guarantee the wavelength multiplexing optical signals to be transmitted along one direction from port b to port c of the high-isolated wavelength managing module 501, for avoiding unnecessary noise resulting from interference.

A wavelength multiplexing communication system, in general, is applied to a long-haul interexchange carrier router. Optical transmission lines used in such a system usually exceed hundreds of kilometers, causing chromatic dispersion to occur in wavelength multiplexing optical signals. Therefore, a dispersion compensator is usually used to compensate for such effects. The following embodiment describes how the dispersion compensator eliminates the chromatic dispersion effect which results from long-distance transmission.

FIG. 6 shows an architecture having a dispersion compensator using the high-isolated wavelength managing module. The “west-to-east” wavelength multiplexing optical signals are inputted to port a of a high-isolated wavelength managing module 601, outputted from port b and then transmitted on an optical transmission line 602. The “east-to-west” wavelength multiplexing optical signals are inputted to port d of the high-isolated wavelength managing module 601, outputted from port b, and then transmitted on the optical transmission line 602. Therefore, the “west-to-east” and “east-to-west” wavelength multiplexing optical signals are merged or combined on the optical transmission line 602 and transmitted along the same direction. The merged or combined optical signals are then inputted to port 1 of an optical circulator 603, redirected to port 2 of the optical circulator 603 and then inputted to a dispersion compensator 605 through an optical transmission line 604. After compensation, the compensated optical signals are again inputted to port 2 and redirected to port 3 of the optical circulator 603. After being outputted from port 3, the optical signals are transmitted on an optical transmission line 606 and then inputted to port c of the high-isolated wavelength managing module 601. The “west-to-east” wavelength multiplexing optical signals are outputted from port d of the high-isolated wavelength managing module 601, and transmitted from west to east on the optical transmission line 120. Meanwhile, the “east-to-west” wavelength multiplexing optical signals are outputted from port a of the high-isolated wavelength managing module 601, and transmitted from east to west on the optical transmission line 119.

As an example, the dispersion compensator 605 can be a linear chirped fiber bragg grating. The short-wave components transmitted faster on the optical transmission line can be reflected after they travel a long distance within the linear chirped fiber bragg grating, by which the chromatic dispersion is compensated.

The following discusses an exchange method for optical signals (information) when a system comprises a number of bi-directional wavelength multiplexing communication systems.

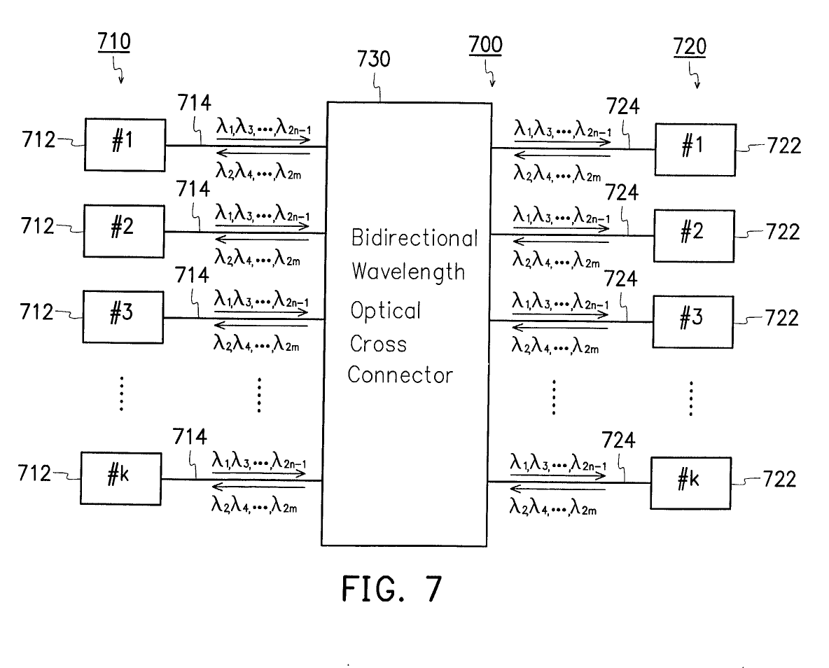

FIG. 7 schematically shows a system block diagram wherein optical signals (information) are exchanged between k bi-directional wavelength multiplexing communication systems. The bi-directional wavelength multiplexing communication systems 710, 720 are numbered from #1 to #7, and each of the bi-directional wavelength multiplexing communication systems 710, 720 comprises a first (west) optical transceiver 712 and a second (east) optical transceiver 722. Each first (west) optical transceiver 712 transmits n “west-to-east” wavelength multiplexing optical signals and receives m “east-to-west” wavelength multiplexing optical signals. Similarly, each second (east) optical transceiver 722 transmits m “east-to-west” wavelength multiplexing optical signals and receives n “east-to-west” wavelength multiplexing optical signals.

One or more bi-directional wavelength interconnects 730 are connected between optical transmission lines 714, 724. The bi-directional wavelength interconnect 730 can rearrange one set of the wavelength multiplexing optical signals from one bi-directional wavelength multiplexing communication system to another one.

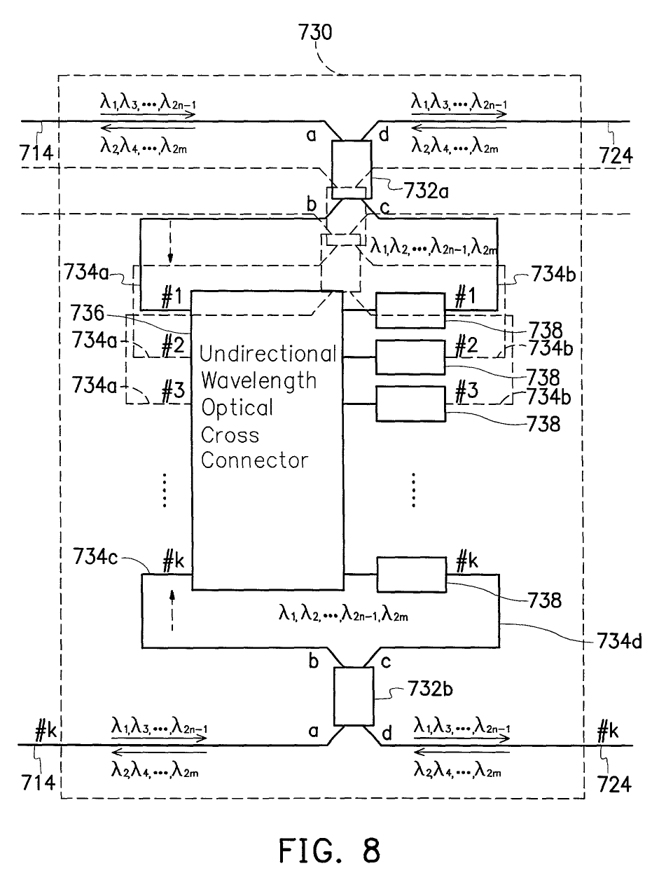

FIG. 8 schematically shows a block diagram of the bi-directional wavelength interconnect 730. The “west-to-east” wavelength multiplexing optical signals from the #1 first optical transceiver 712 are inputted to port a, outputted from port b of the high-isolated wavelength managing module 732a, and then transmitted on a #1 optical transmission line 734a. The “east-to-west” wavelength multiplexing optical signals from the #1 second optical transceiver 722 are inputted to port d, outputted from port b of the high-isolated wavelength managing module 732a, and then transmitted on the #1 optical transmission line 734a. Therefore, the “west-to-east” and “east-to-west” wavelength multiplexing optical signals of the #1 bi-directional wavelength multiplexing communication system are merged or combined on the #1 optical transmission line 734a and transmitted alone the same direction, and then inputted to #1 input port of a wavelength crossconnect 736. The other sets of wavelength multiplexing optical signals for #2˜#k bi-directional wavelength multiplexing communication systems work in the same way, and is respectively inputted to corresponding #2˜#k input ports of the wavelength crossconnect 736. After the inputted optical signals are exchanged within the wavelength crossconnect 736, the wavelength multiplexing optical signals are outputted from a selected output port, #1˜#k, of the wavelength crossconnect 736, and then passed through a corresponding isolator 738 (#1˜#k), and finally inputted to port c of the high-isolated wavelength managing module 732a through a #1 optical transmission line 734b. Then, the “west-to-east” wavelength multiplexing optical signals are outputted from port d of the high-isolated wavelength managing module 732a, and continuously transmitted on the transmission line 724 from west to east. And, the “east-to-west” wavelength multiplexing optical signals are outputted from port a of the high-isolated wavelength managing module 732a and continuously transmitted on the transmission line 714 from east to west.

Generally, the wavelength crossconnect 736 comprises k demultiplexers (DEMUX) capable of dividing wavelengths λ1, λ2, . . . , λ2n−1, λ2m, (n+m) k×k optical switches and k multiplexers for wavelengths λ1, λ2, . . . , λ2n−1, λ2m.

The high-isolation wavelength managing module provides the benefit of a higher isolation property than a general wavelength managing module. The following descriptions discuss how to modify the high-isolation wavelength managing module 732a to be capable of performing some optical function and benefit a higher isolation at the same time.

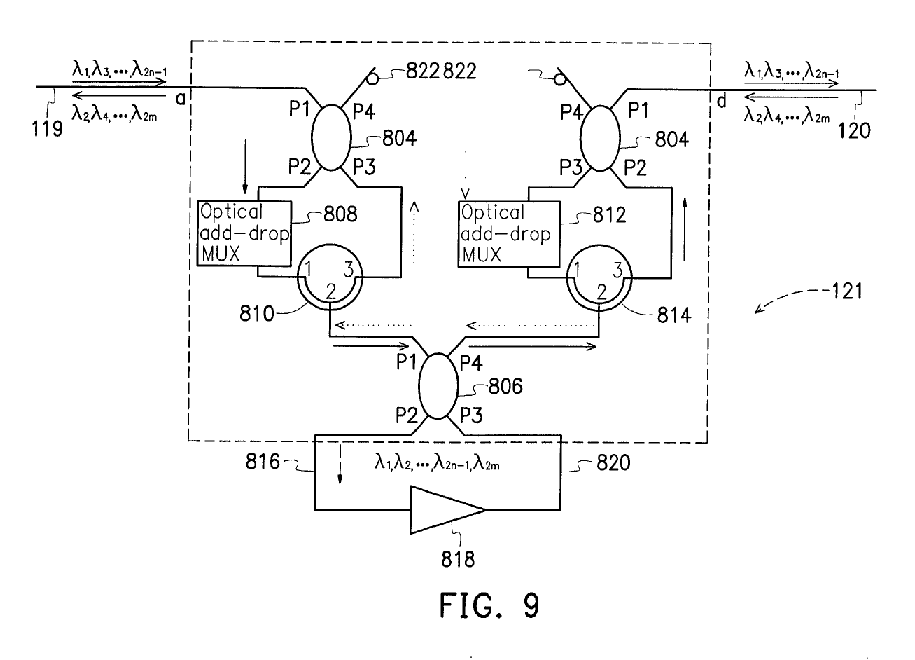

FIG. 9 shows a block diagram which modifies the high-isolated wavelength managing module to provide the capability of performing an add-drop process and then amplifying the “west-to-east” and “east-to-west” wavelength multiplexing optical signals. As shown, the dashed line indicates the high-isolated wavelength managing module. The “west-to-east” wavelength multiplexing optical signals are inputted to the first port p1 and outputted from port p2 of the wavelength managing module 802, and then transmitted to an optical adding and dropping multiplexer 808 designed for optical signals with wavelengths λ1, λ3, . . . , λ2n−1. After adding and dropping, the optical signals are inputted to port 1 of the optical circulator 810 and then redirected for outputting from port 2 of the optical circulator 810. The optical signals are then transmitted to port p1 of the wavelength managing module 806 and then redirected to port p2 for outputting and then transmitted on an optical transmission line 816. The “east-to-west” wavelength multiplexing optical signals are inputted to port p4 and outputted from port p2 of the wavelength managing module 804, and then transmitted to an optical adding and dropping multiplexer 812 designed for optical signals with wavelengths λ2, λ4, . . . , λ2m−1. After adding and dropping, the optical signals are inputted to port 1 of the optical circulator 814 and then redirected for outputting from port 2 of the optical circulator 814. The optical signals are then transmitted to port p4 of the wavelength managing module 806, redirected to port p2 for outputting, and then transmitted on the optical transmission line 816. Therefore, the “west-to-east” and “east-to-west” optical signals are merged or combined on the transmission line 816 and transmitted along the same direction.

After the optical signals are amplified by an amplifier module 818, the merged optical signals are transmitted to port p3 of the wavelength managing module 806 through an optical transmission line 820. The “west-to-east” optical signals are outputted from port p4 and then inputted to port 2 of the optical circulator 814. After passing through the optical circulator 814, the optical signals are outputted from port p3 of the optical circulator 814 and transmitted to port p2 of the wavelength managing module 804. Finally, the optical signals are outputted from port p4 of the wavelength managing module 804, and then transmitted on the optical transmission line 120. Similarly, the “east-to-west” optical signals are outputted from port p1 and then inputted to port 2 of the optical circulator 810. After passing through the optical circulator 810, the optical signals are outputted from port p3 of the optical circulator 810 and transmitted to port p3 of the wavelength managing module 802. Finally, the optical signals are outputted from port p1 of the wavelength managing module 802, and then transmitted on the optical transmission line 119.

Comparing the structures between the foregoing and FIG. 5, the structure in FIG. 9 advantages that the “west-to-east” and “east-to-west” optical signals can be processed separately, and therefore, the channel width of the adding and dropping multiplexer can be doubled. For example, as shown in FIG. 9, the channel spacing (λ3−λ1) of the adding and dropping multiplexer 808 and the channel spacing (λ4−λ2) of the adding and dropping multiplexer 812 are the same, but twice that of the channel spacing (λ2−λ1) of the adding and dropping multiplexer 503 shown in FIG. 5.

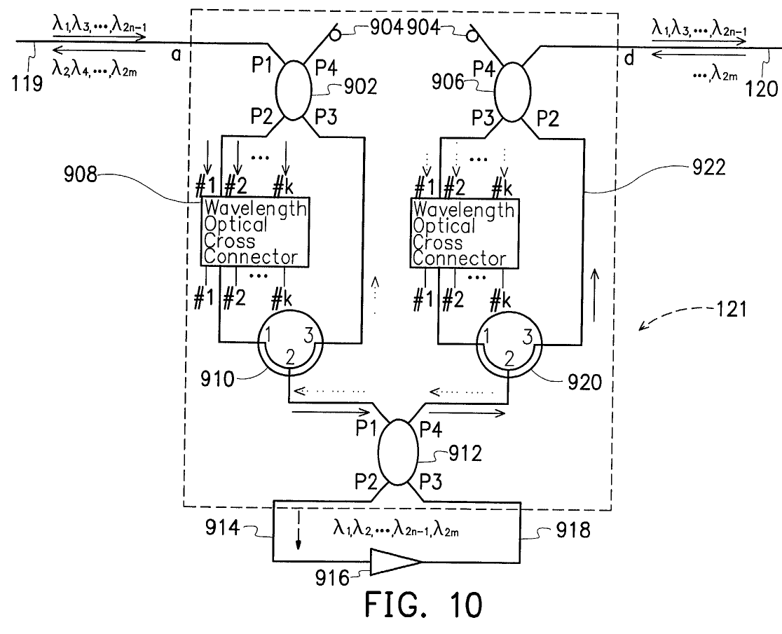

FIG. 10 shows a block diagram of a high-isolated bi-directional optical function module which modifies the high-isolated wavelength managing module to enable the capability of performing a wavelength crossconnect process, and then amplifying the “west-to-east” and “east-to-west” wavelength multiplexing optical signals. The dashed line indicates the high-isolated wavelength managing module. The “west-to-east” wavelength multiplexing optical signals, from the #1 optical transceiver 712 (see FIG. 7), are inputted to the first port p1 and outputted from port p2 of the #1 wavelength managing module 902, and then transmitted to a #1 input port of a wavelength crossconnect 908 designed for optical signals with wavelengths λ1, λ3, . . . , λ2n−1. After optical signals are exchanged, the optical signals are inputted to port p1 of the optical circulator 910 and then redirected for outputting from port p2 of the optical circulator 910. Then, the optical signals are transmitted to port p1 of the wavelength managing module 912, redirected to port p2 for outputting, and then transmitted on an optical transmission line 914. The “east-to-west” wavelength multiplexing optical signals are inputted to port p4 and outputted from port p2 of the wavelength managing module 906, and then transmitted to a #1 input port of a wavelength crossconnect 922 designed for optical signals with wavelengths λ2, λ4, . . . , λ2m−1. After the optical signals are exchanged, the optical signals are inputted to port p1 of the optical circulator 920 and then redirected for outputting from port p2 of the optical circulator 920. Then, the optical signals are transmitted to port p4 of the wavelength managing module 912 and then redirected to port p2 for outputting and then transmitted on the optical transmission line 914. Therefore, the “west-to-east” and “east-to-west” optical signals are merged or combined on the transmission line 914 and transmitted along the same direction.

After the optical signals are amplified by an amplifier module 916, the merged optical signals are transmitted to port p3 of the wavelength managing module 912 through an optical transmission line 918. The “west-to-east” optical signals are outputted from port p4 and then inputted to port p2 of the optical circulator 920. After passing through the optical circulator 920, the optical signals are outputted from port p3 of the optical circulator 920 and transmitted to port p2 of the wavelength managing module 906. Finally, the optical signals are outputted from port p4 of the wavelength managing module 906, and then transmitted on the optical transmission line 120. Similarly, the “east-to-west” optical signals are outputted from port p1 and then inputted to port p2 of the optical circulator 910. After passing through the optical circulator 910, the optical signals are outputted from port p3 of the optical circulator 910 and transmitted to port p3 of the wavelength managing module 902. Finally, the optical signals are outputted from port p1 of the wavelength managing module 902, and then transmitted on the optical transmission line 119.

Generally, the wavelength crossconnect 908 comprises k demultiplexers (DEMUX) capable of dividing wavelengths λ1, λ3, . . . , λ2n−1, n k×k-optical switches and k multiplexers for wavelengths λ1, λ3, . . . , λ2n−1. The wavelength crossconnect 922 comprises k demultiplexers (DEMUX) capable of dividing wavelengths λ2, λ4, . . . , λ2m, m k×k-optical switches and k multiplexers for wavelengths λ2, λ4, . . . , λ2m. The “west-to-east” and “east-to-west” optical signals can be processed separately, and therefore, the channel width of the multiplexers and demultiplexer of the wavelength crossconnects 908, 922 can be doubled as the channel width of the multiplexers and demultiplexer of the wavelength crossconnects 736 shown in FIG. 8.

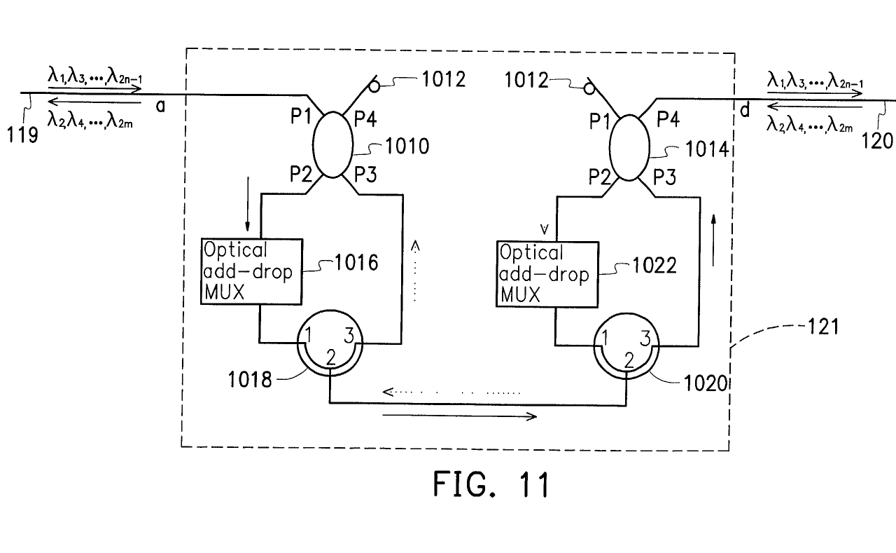

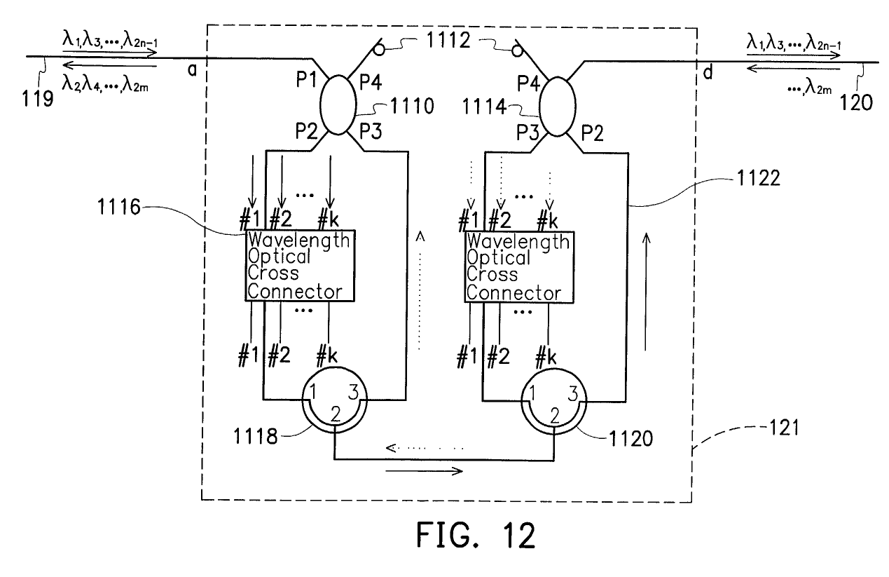

If it is unnecessary for the optical signals to be amplified after they pass through the optical adding and dropping multiplexers or wavelength crossconnects, only the channel spacings of the optical adding and dropping multiplexers or wavelength crossconnects are required to be increased. The structure shown in FIG. 11 or FIG. 12 is then a good choice to omit the optical amplifier module.

The present system further provides a high-isolated wavelength managing module, using 2×2 components as a wavelength managing module. Optical fiber loops of the 2×2 wavelength managing module form a so-called self-loop for increasing isolation of the wavelength managing module.

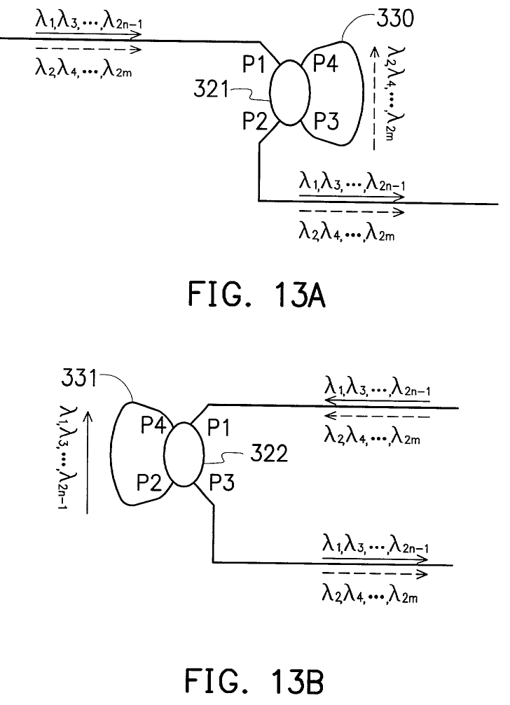

FIG. 13A shows a wavelength managing module 321, which is a 2×2 MWDM device with self-loops. The wavelength managing module 321 comprises four ports p1˜p4, in which ports p1, p4 are input ports, and ports p2, p3 are output ports. The ports p2 and p4 are connected by an optical fiber 330 to form a self-loop. For example, if optical signals with 8 wavelengths λ1, λ2, . . . , λ8 are inputted to port p1 in which the optical signals with wavelengths λ1, λ3, λ5, λ7 are outputted from port p2 and the optical signals with wavelengths λ2, λ4, λ6, λ8 are outputted from port p3. Due to the existence of the optical self-loop 330, the optical signals with wavelengths λ2, λ4, λ6, λ8 are directed to port 3 through the self-loop 330 and then output from port p2. Thus, the optical signals with even-numbered wavelengths λ2, λ4, λ6, λ8 are passed the wavelength managing module 321 twice. Therefore, the optical signals with even-numbered wavelengths are highly isolated.

FIG. 13B shows a wavelength managing module 322, which is a 2×2 MWDM device with self-loops. The wavelength managing module 322 comprises four ports p1˜p4, in which ports p1, p4 are input ports, and ports p2, p3 are output ports. The ports p2 and p4 are connected by an optical fiber 331 to form a self-loop. For example, if optical signals with 8 wavelengths λ1, λ2, . . . , λ8 are inputted to port p1 in which the optical signals with wavelengths λ2, λ4, λ6, λ8 are outputted from port p3 and the optical signals with wavelengths λ1, λ3, λ5, λ7 are outputted from port p2. Due to the existence of the optical self-loop 321, the optical signals with wavelengths λ1, λ3, λ5, λ7 are directed to port 4 through the self-loop 330 and then output from port p3. Thus, the optical signals with even-numbered wavelengths λ1, λ3, λ5, λ7 are passed to the wavelength managing module 322 twice. Therefore, the optical signals with odd-numbered wavelengths are highly isolated.

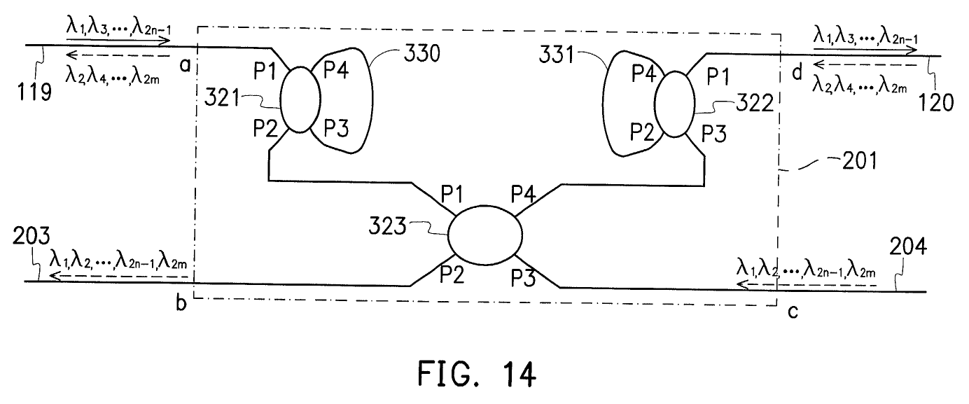

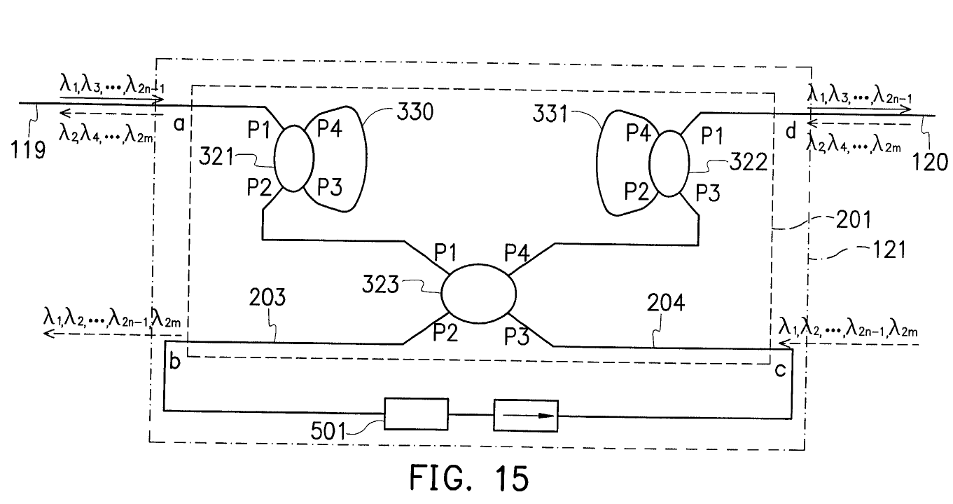

FIG. 14 shows a schematic diagram of a high-isolated wavelength managing module. The high-isolated wavelength managing module 201 comprises a first wavelength managing module 321 as shown in FIG. 13A, a second wavelength managing module 322 as shown in FIG. 13B and a third wavelength managing module 323. As shown, the “west-to-east” wavelength multiplexing optical signals λ1, λ3, λ5, λ7 are inputted to port a of the high-isolated wavelength managing module 201 and then transmitted to port p1 of the first wavelength managing module 321. The optical signals λ1, λ3, λ5, λ7 are then outputted from port p2 and transmitted to port p1 of the third wavelength managing module 323. Finally, the optical signals λ1, λ3, λ5, λ7 are outputted from port p2 and transmitted on the optical transmission line 203.

The “east-to-west” wavelength multiplexing optical signals λ2, λ4, λ6, λ8 are inputted to port d of the high-isolated wavelength managing module 201 and then transmitted to port p1 of the second wavelength managing module 322. The optical signals λ2, λ4, λ6, λ8 are then outputted from port p3 and transmitted to port p4 of the third wavelength managing module 323. Finally, the optical signals λ2, λ4, λ6, λ8 are outputted from port p2 and transmitted on the optical transmission line 203. Therefore, the “west-to-east” and “east-to-west” optical signals are merged or combined on the optical transmission line 203 and transmitted alone in one direction. All optical signals (odd- and even-numbered wavelengths) are passed through the high-isolated wavelength managing module 201 twice: once for the wavelength managing module 321 and once for the wavelength managing module 323 with regard to the odd-numbered wavelengths, and once for the wavelength managing module 322 and once for the wavelength managing module 323 with regard to the even-numbered wavelengths.

FIG. 15 shows a structure illustrating how to use the high-isolated wavelength managing module shown in FIG. 14 such that the “west-to-east” and “east-to-west” optical signals of the high-isolated bi-directional optical function module can be amplified, or added and dropped. After the optical signals are passed through an optical function module 501 (such as amplified by an optical amplifier), the optical signals are transmitted on an optical transmission line 204 and then are connected to port p3 of the third wavelength managing module through port c of the high-isolated wavelength managing module 201. The “west-to-east” optical signals λ1, λ3, λ5, λ7 (odd-numbered) are outputted from port p4 of the third wavelength managing module 323, transmitted to port p3 and, in turn, transmitted to port p4 of the second wavelength managing module 322. After being outputted from port p4, the optical signals are further transmitted to port p2 of the second wavelength managing module 322 through self-loop 331. Finally, the optical signals are transmitted on the optical transmission line 120. Similarly, the “east-to-west” optical signals λ2, λ4, λ6, λ8 (even-numbered) are outputted from port p1 of the third wavelength managing module 323, transmitted to port p2 and in turn to port p4 of the first wavelength managing module 321. After being outputted from port p4, the optical signals are further transmitted to port p3 of the first wavelength managing module 321 through self-loop 330. Finally, the optical signals are transmitted on the optical transmission line 119. All of the optical signals λ1, λ2, . . . , λ7, λ8 are passed through the wavelength managing module five times. The odd-numbered optical signals, λ1, λ3, λ5, λ7, pass through the wavelength managing module 321 once, the wavelength managing module 323 twice, and wavelength managing module 322 twice. The even-numbered optical signals, λ2, λ4, λ6, λ8, pass through the wavelength managing module 322 once, the wavelength managing module 323 twice, and wavelength managing module 321 twice. Therefore, isolation between neighboring wavelengths can be effectively increased.

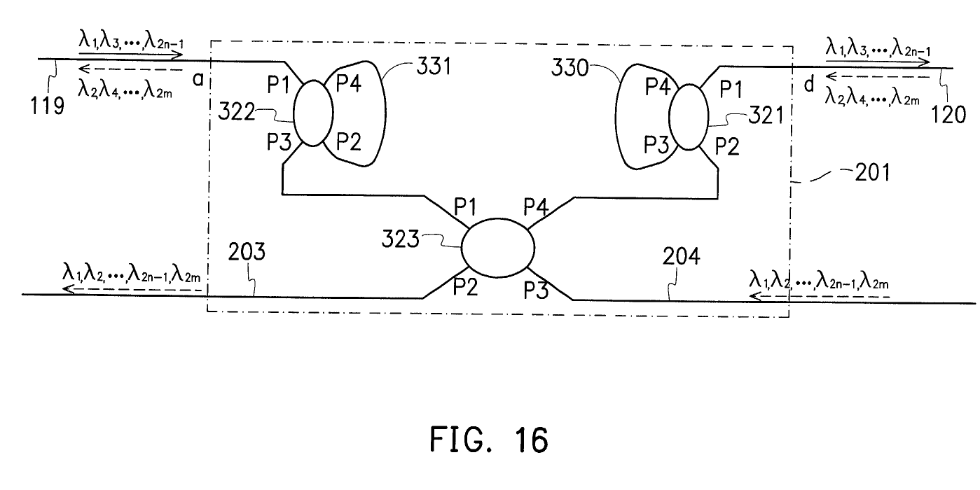

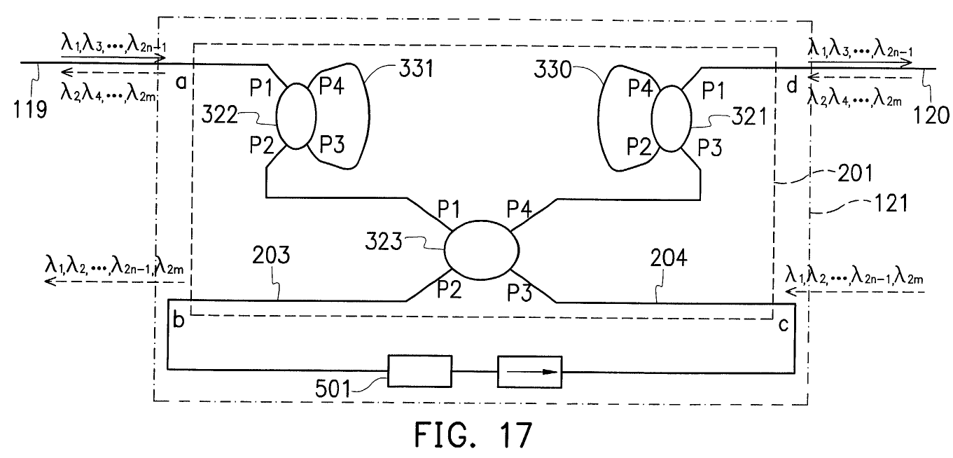

FIG. 16 shows another embodiment of the high-isolated wavelength managing module according to the present invention. The high-isolated wavelength managing module 201 comprises a first wavelength managing module 321 as shown in FIG. 13A, a second wavelength managing module 322 as shown in FIG. 13B, and a third wavelength managing module 323. The difference from FIG. 14 is that the positions of the first and second wavelength managing modules 321, 322 are exchanged. As shown, the “west-to-east” optical signals λ1, λ3, λ5, λ7 are transmitted to port p1 of the second wavelength managing modules 322 through port a of the high-isolated wavelength managing module 201, and then outputted from port p2 of the second wavelength managing modules 322. The optical signals λ1, λ3, λ5, λ7 are then redirected to port p4 through the self-loop 331 and then outputted to port p3. The optical signals are continuously transmitted from port p3 of the second wavelength managing module 322 to port p1 of the wavelength managing module 323. Finally, the optical signals are outputted from port p2 of the wavelength managing module 323 and then transmitted on the optical transmission line 203.

The “east-to-west” optical signals λ2, λ4, λ6, λ8 are transmitted from port p1 of the first wavelength managing module 321, through port d of the high-isolated wavelength managing module 201, and then outputted from port p3. Then, the optical signals are reentered to port p4 of the first wavelength managing module 321 through the self-loop 330, and then outputted from port p2. The optical signals then propagate to port p4 of the third wavelength managing module 323, outputted from port p2 of the third wavelength managing module 323 and transmitted on the optical transmission line 203. All of the optical signals λ1, λ2, . . . , λ7, λ8 are passed through the wavelength managing module three times. The odd-numbered optical signals, λ1, λ3, λ5, λ7, pass through the wavelength managing module 322 twice and the wavelength managing module 323 once. The even-numbered optical signals, λ2, λ4, λ6, λ8, pass through the wavelength managing module 321 twice and the wavelength managing module 323 once. Therefore, isolation between neighboriong wavelengths can be effectively increased.

FIG. 17 shows a structure wherein the high-isolated wavelength managing module in FIG. 16 is applied to the high-isolated bi-directional optical function module, such that the “west-to-east” and “east-to-west” optical signals of the high-isolated bi-directional optical function module can be amplified, or added and dropped. After the optical signals are passed through the optical function module 501 (such as amplified by an optical amplifier), the optical signals are transmitted on an optical transmission line 204 and then are connected to port p3 of the third wavelength managing module through port c of the high-isolated wavelength managing module 201. The “west-to-east” optical signals, λ1, λ3, λ5, λ7 (odd-numbered) are outputted from port p4 of the third wavelength managing module 323, transmitted to port p2 and, in turn, to port p1 of the first wavelength managing module 321. Finally, the optical signals are transmitted on the optical transmission line 120. Similarly, the “east-to-west” optical signals, λ2, λ4, λ6, λ8 (even-numbered) are outputted from port p1 of the third wavelength managing module 323, transmitted to port p2 of the second wavelength managing module 322. Finally, the optical signals are transmitted on the optical transmission line 119. All of the optical signals λ1, λ2, . . . , λ7, λ8 are passed through the wavelength managing module five times. For the odd-numbered optical signals λ1, λ3, λ5, λ7, they pass through the wavelength managing module 321 once, the wavelength managing module 323 twice, and wavelength managing module 322 twice. For the even-numbered optical signals, λ2, λ4, λ6, λ8, pass through the wavelength managing module 322 once, the wavelength managing module 323 twice and wavelength managing module 321 twice. Therefore, isolation between neighboring wavelengths can be effectively increased.

In general, the wavelength managing modules 321, 322 and 323, for example, can be multi-window wavelength division multiplexers (MWDM), fabricated by fused-biconical taper method (FBT) or unbalanced Mach-Zehnder interferometer (UMZI) technology. The wavelength managing module is also named as an optical wavelength interleaver because wavelengths are interleavely appeared and distributed on their two output ports when a number of wavelengths with constant frequency spacings are inputted to such module.

In summary, the present invention provides at least the following benefits:

1. High isolation. The optical signals are passed through the general wavelength managing modules four times and the optical circulators twice when they are inputted to the high-isolated wavelength managing module. Therefore, for the high-isolated wavelength managing module, the insertion loss becomes larger by 2.2-2.6 dB and the bandwidth becomes smaller than conventional wavelength managing module. However, the isolation of the high-isolated wavelength managing module of the present invention is double.

2. Large design flexibility. The bi-directional wavelength multiplexing optical signals can be processed together, such as the structures shown in FIGS. 2, 5, 6 and 8. In addition, theses optical signals can be processed separately, such as the structures shown in FIGS. 9 and 10. Further, the optical signals can be processed separately but not passed through an optical function module, such as the structures shown in FIGS. 11 and 12.

3. The high-isolated wavelength managing module having a configuration comprising a number of wavelength managing modules with self-loops and a wavelength managing module without self-loops can increase isolation ability such that the optical signals passed through the high-isolated wavelength managing module are well isolated.

4. The high-isolated wavelength managing module of the invention is composed of several 2×2 wavelength managing modules having similar optical property, by which the manufacturing cost decreases and device specification is more consistent.

While the present invention has been described with a preferred embodiment, this description is not intended to limit our invention. Various modifications of the embodiment will be apparent to those skilled in the art. It is therefore contemplated that the appended claims will cover any such modifications or embodiments that fall within the true scope of the invention.

What claimed is:

1. A high-isolated wavelength managing module, having a first, a second, a third and a fourth ports, comprising:
a plurality of wavelength managing modules, wherein one port of one of the wavelength managing modules connected to the first port of the high-isolated wavelength managing module for receiving and carrying first optical signals with different wavelengths, and one port of another wavelength managing module connected to the fourth port of the high-isolated wavelength managing module for receiving and carrying second optical signals with different wavelengths, the first and the second optical signals are transmitted in opposite direction and with different wavelengths; and
a plurality of optical circulators, optically coupled among the wavelength managing modules.

2. The high-isolated wavelength managing module of claim 1, wherein the wavelength managing modules comprise a first, a second and a third wavelength managing modules, and the optical circulators comprise a first and a second optical circulators.

3. The high-isolated wavelength managing module of claim 2, wherein the first wavelength managing module is coupled to the first port of the high-isolated wavelength managing module, the second wavelength managing module is coupled to the fourth port of the high-isolated wavelength managing module, the first optical circulator is coupled between the first and the third wavelength managing modules, and the second optical circulator is coupled between the second and the third wavelength managing modules.

4. The high-isolated wavelength managing module of claim 3, wherein each of the first, the second and the third wavelength managing modules comprises four ports, and
the first port of the first wavelength managing module is connected to the first port of the high-isolated wavelength managing module;
the first port of the second wavelength managing module is connected to the fourth port of the high-isolated wavelength managing module; and
the second port of the third wavelength managing module is connected to the second port of the high-isolated wavelength managing module, and
the third port of the third wavelength managing module is connected to the third port of the high-isolated wavelength managing module.

5. The high-isolated wavelength managing module of claim 4, wherein each of the optical circulators comprises at least three ports, and
the first port of the first optical circulator is connected to the second port of the first wavelength managing module;
the second port of the first optical circulator is connected to the first port of the third wavelength managing module;
the third port of the first optical circulator is connected to the third port of the first wavelength managing module, and
the first port of the second optical circulator is connected to the third port of the second wavelength managing module;
the second port of the second optical circulator is connected to the fourth port of the third wavelength managing module; and
the third port of the first optical circulator is connected to the second port of the second wavelength managing module.

6. The high-isolated wavelength managing module of claim 2, further comprising:
a first optical adding and dropping multiplexer coupled between the first wavelength managing module and the first optical circulator; and
a second optical adding and dropping multiplexer coupled between the second wavelength managing module and the second optical circulator.

7. The high-isolated wavelength managing module of claim 2, wherein the first and the second optical signals respectively pass through the first wavelength managing module once, the third wavelength managing module twice, the second wavelength managing module once, the first optical circulator once and the second optical circulator once.

8. The high-isolated wavelength managing module of claim 2, further comprising:
a first wavelength crossconnect coupled between the first wavelength managing module and the first optical circulator; and
a second wavelength crossconnect coupled between the second wavelength managing module and the second optical circulator.

9. The high-isolated wavelength managing module of claim 2, further comprising an optical gain module coupled between the second and the third ports of the third wavelength managing module by optical transmission lines to form a high-isolated bi-directional optical function module.

10. The high-isolated wavelength managing module of claim 2, further comprising a three-port optical circulator and at least one optical fiber grating, wherein the three-port optical circulator and the optical fiber grating coupled between the second and the third ports of the third wavelength managing module by optical transmission lines to form a high-isolated bi-directional optical function module.

11. The high-isolated wavelength managing module of claim 9, wherein the optical gain module further comprises an optical fiber doped with a rare-earth element, at least one light source, a first and a second optical fiber isolator.

12. The high-isolated wavelength managing module of claim 1, wherein the wavelength managing modules comprise a first and a second wavelength managing modules, and the optical circulators comprise a first and a second optical circulators.

13. The high-isolated wavelength managing module of claim 12, wherein the first wavelength managing module is coupled to the first port of the high-isolated wavelength managing module, the second wavelength managing module is coupled to the fourth port of the high-isolated wavelength managing module, the first optical circulator is coupled to the first wavelength managing module, and the second optical circulator is coupled to the second wavelength managing modules and in turn to the first optical circulator, thereby the first wavelength managing module, the first optical circulator, the second optical circulator, and the second wavelength managing module form an optical transmission channel.

14. The high-isolated wavelength managing module of claim 13, wherein each of the first and the second wavelength managing modules comprises four ports, and
the first port of the first wavelength managing module is connected to the first port of the high-isolated wavelength managing module and the fourth port of the second wavelength managing module is connected to the fourth port of the high-isolated wavelength managing module.

15. The high-isolated wavelength managing module of claim 14, wherein each of the first and the second optical circulators comprises at least three ports, and
the first port of the first optical circulator is connected to the second port of the first wavelength managing module,
the second port of the first optical circulator is connected to the second port of the first optical circulator,
the third port of the first optical circulator is connected to the third port of the first wavelength managing module; and
the first port of the second optical circulator is connected to the second port of the second wavelength managing module,
the second port of the second optical circulator is connected to the second port of the first optical circulator,
the third port of the second optical circulator is connected to the third port of the second wavelength managing module.

16. The high-isolated wavelength managing module of claim 13, further comprising:
a first optical adding and dropping multiplexer coupled between the first wavelength managing module and the first optical circulator; and
a second optical adding and dropping multiplexer coupled between the second wavelength managing module and the second optical circulator.

17. The high-isolated wavelength managing module of claim 13, further comprising:
a first wavelength crossconnect coupled between the first wavelength managing module and the first optical circulator; and
a second wavelength crossconnect coupled between the second wavelength managing module and the second optical circulator.

18. A high-isolated bidirectional optical function module, for automatically exchanging optical signals, comprising:
at least one high-isolated wavelength managing module, wherein the first port of the high-isolated wavelength managing module receives and carries first optical signals with different wavelengths, and the fourth port of the high-isolated wavelength managing module receives and carries second optical signals with different wavelengths, the first and the second optical signals are transmitted in opposite direction and with different wavelengths;
a set of optical transmission lines coupled between the first and the fourth ports of the high-isolated wavelength managing module; and
at least one uni-directional optical function module with an isolation capability, coupled between the second and the third ports of the high-isolated wavelength managing module.

19. The high-isolated bi-directional optical function module of claim 18, wherein the uni-directional optical function module with an isolation capability comprises an optical gain module, coupled between the second and the third ports of the high-isolated wavelength managing module.

20. The high-isolated bi-directional optical function module of claim 19, wherein the optical gain module further comprises an optical fiber doped with a rare-earth element, at least one light source, a first and a second optical fiber isolator.

21. The high-isolated bi-directional optical function module of claim 18, wherein the uni-directional optical function module with an isolation capability comprises a chromatic dispersion compensator, coupled between the second and the third ports of the high-isolated wavelength managing module.

22. The high-isolated bidirectional optical function module of claim 21, wherein the chromatic dispersion compensator further comprises an optical fiber grating.

23. The high-isolated bi-directional optical function module of claim 21, wherein the chromatic dispersion compensator further comprises at least one three-port optical circulator and an optical fiber grating.

24. A high-isolated bi-directional optical function module, for automatically exchanging optical signals, comprising:
at least one high-isolated wavelength managing module, the high-isolated wavelength managing module having four ports, wherein the first port of the high-isolated wavelength managing module receives and carries first optical signals with different wavelengths, and the fourth port of the high-isolated wavelength managing module receives and carries second optical signals with different wavelengths, the first and the second optical signals are transmitted in opposite direction and with different wavelengths;
a set of optical transmission lines coupled between the first and the fourth ports of the high-isolated wavelength managing module;
at least one uni-directional optical function module, coupled between the second and the third ports of the high-isolated wavelength managing module; and
at least one optical isolator, optically coupled between the uni-directional optical function module and the third port of the high-isolated wavelength managing module.

25. A high-isolated bi-directional optical function system, for automatically exchanging optical signals, comprising:
a plurality of high-isolated wavelength managing modules, wherein the first port of the high-isolated wavelength managing module receives and carries first optical signals with different wavelengths, and the fourth port of the high-isolated wavelength managing module receives and carries second optical signals with different wavelengths, the first and the second optical signals are transmitted in opposite direction and with different wavelengths;
at least one uni-directional wavelength crossconnect having a plurality of input ports and a plurality of output ports, each of the input and output ports being respectively coupled to the each second and third ports of the high-isolated wavelength managing modules; and
a plurality of optical isolators, optically coupled between the uni-directional wavelength crossconnect and each third port of the corresponding high-isolated wavelength managing module.

26. The high-isolated bi-directional optical function system of claim 25, wherein the number of the high-isolated wavelength managing modules is consistent with input optical transmission lines of the high-isolated bi-directional optical function system.

27. The high-isolated bi-directional optical function system of claim 25, wherein the number of the optical isolators is consistent with the input optical transmission lines of the high-isolated bi-directional optical function system.

28. A high-isolated wavelength managing module, having a first, a second, a third and a fourth ports, comprising:
a plurality of wavelength managing modules with self-loops, wherein one port of one of the wavelength managing modules with self-loops connected to the first port of the high-isolated wavelength managing module for receiving and carrying first optical signals with different wavelengths, and one port of another wavelength managing module with self-loops connected to the fourth port of the high-isolated wavelength managing module for receiving and carrying second optical signals with different wavelengths, the first and the second optical signals are transmitted in opposite direction and with different wavelengths; and
a wavelength managing module without self-loops, coupled between the wavelength managing modules with self-loops.

29. The high-isolated wavelength managing module of claim 28, wherein the wavelength managing modules with self-loops comprise a first and a second wavelength managing modules with self-loops.

30. The high-isolated wavelength managing module of claim 28, wherein the first wavelength managing module with self-loops is coupled to the first port of the high-isolated wavelength managing module, the second wavelength managing module with self-loops is coupled to the fourth port of the high-isolated wavelength managing module, and the wavelength managing module without self-loops is coupled between the first and the second wavelength managing modules with self-loops.

31. The high-isolated wavelength managing module of claim 30, wherein each of the first and the second wavelength managing modules with self-loops and the wavelength managing module without self-loops comprises four ports, and
the first port of the first wavelength managing module with self-loops is connected to the first port of the high-isolated wavelength managing module,
the first port of the second wavelength managing module with self-loops is connected to the fourth port of the high-isolated wavelength managing module,
the second port of the wavelength managing module without self-loops is connected to the second port of the high-isolated wavelength managing module, and
the third port of the wavelength managing module without self-loops is connected to the third port of the high-isolated wavelength managing module.

32. The high-isolated wavelength managing module of claim 31, wherein the first port of the wavelength managing module without self-loops is connected to the second port of the first wavelength managing module with self-loops, and the fourth port of the wavelength managing module without self-loops is connected to the third port of the second wavelength managing module with self-loops.

33. The high-isolated wavelength managing module of claim 32, wherein the third and the fourth ports of the first wavelength managing module with self-loops are connected to form a self-loop, and the second and the fourth ports of the second wavelength managing module with self-loops are connected to form a self-loop.

34. The high-isolated wavelength managing module of claim 33, wherein the self-loops are connected by optical fibers.

35. The high-isolated wavelength managing module of claim 29, further comprising an optical function module coupled between the second and the third ports of wavelength managing module without self-loops to form a high-isolated bi-directional optical function module.

36. The high-isolated wavelength managing module of claim 35, wherein the optical function module comprises an optical gain module.

37. The high-isolated wavelength managing module of claim 35, wherein the optical function module comprises an optical add-drop module.
